(19) United States
(12) Patent Application Publication
(10) Pub. No.: US 2017/0359656 A1
(43) Pub. Date: Dec. 14, 2017

(54) ELECTRO-ACOUSTIC DRIVER AND BOBBIN THEREFORE

(71) Applicant: Bose Corporation, Framingham, MA (US)

(72) Inventors: Wit Bushko, Medway, MA (US); Thomas Landemaine, Allston, MA (US); Prateek Nath, Southborough, MA (US)

(73) Assignee: Bose Corporation, Framingham, MA (US)

(21) Appl. No.: 15/617,108

(22) Filed: Jun. 8, 2017

Related U.S. Application Data
(63) Continuation-in-part of application No. 15/182,055, filed on Jun. 14, 2016.

(51) Int. Cl. H04R 7/24; H04R 7/04; H04R 9/06; H04R 9/02; H04R 7/16

(52) U.S. Cl. CPC H04R 7/24; H04R 9/025; H04R 7/16; H04R 9/06; H04R 7/04

(57) ABSTRACT

A bobbin for an electro-acoustic driver includes an outer surface, a substantially planar surface at an end of the bobbin, and a bobbin axis that is substantially coaxial with a housing axis. The bobbin is disposable inside a housing and configured to move along the bobbin axis. The substantially planar surface at the end of the bobbin is securable to an acoustic diaphragm. The bobbin includes one or more of (a) legs extending from the outer surface to the substantially planar surface, (b) a wall which extends about substantially all of a perimeter of the planar surface, and (c) a plurality of through holes in the substantially planar surface.

### RELATED APPLICATION

This application is a continuation-in-part application of U.S. patent application Ser. No. 15/182,055, filed Jun. 14, 2016 and titled “Electro-acoustic Driver having Compliant Diaphragm With Stiffening Element,” the contents of which are incorporated herein by reference.

### BACKGROUND

This disclosure relates to an electro-acoustic device and a bobbin therefore.

### SUMMARY

In general, in one aspect, an electro-acoustic driver includes a diaphragm formed of a compliant material and having a perimeter, a front surface, a back surface, an inner region and an outer region between the perimeter and the inner region, and a substantially planar shape when the diaphragm is at rest. A bobbin has an inner surface, an outer surface and a bobbin axis. The bobbin is configured to hold a winding of an electrical conductor on the outer surface. A housing has an end and a housing axis that is substantially coaxial with the bobbin axis. The perimeter of the diaphragm is fixed to the end of the housing. A stiffening element is fixed to one or more of the front surface and the back surface at the inner region of the diaphragm. A motion of the bobbin along the bobbin axis generates a movement of the inner region of the diaphragm to thereby generate an acoustic signal that propagates from the front surface of the diaphragm. The bobbin further includes a substantially planar surface at an end of the bobbin which is normal to the bobbin axis and fixed to the back surface of the diaphragm at the inner region. The stiffening element includes the substantially planar surface of the bobbin. The bobbin includes one or more of (a) legs extending from the outer surface to the substantially planar surface, and (b) a plurality of through holes in the substantially planar surface.

Implementations may include one or more of the following, in any combination. The substantially planar surface is fixed directly to the back surface of the diaphragm. The driver further includes a layer of adhesive to fix the substantially planar surface of the bobbin to the back surface of the diaphragm at the inner region. The bobbin has an outer diameter and the inner region of the diaphragm has a diameter that is substantially equal to the outer diameter of the bobbin. The outer region has an annular shape. The bobbin includes both of (a) legs extending from the outer surface to the substantially planar surface, and (b) the plurality of through holes in the substantially planar surface. The bobbin includes four legs extending from the outer surface to the substantially planar surface.

In general, in another aspect, an electro-acoustic driver includes a housing having a cylindrical shape and a housing axis. A bobbin has an outer surface, a substantially planar surface at an end of the bobbin, and a bobbin axis that is substantially coaxial with the housing axis. The bobbin is disposed inside the housing and configured to move along the bobbin axis. An acoustic diaphragm is secured to the substantially planar surface at the end of the bobbin. A compliant suspension surrounds the acoustic diaphragm and is secured to the acoustic diaphragm and the housing. The bobbin includes one or more of (a) legs extending from the outer surface to the substantially planar surface, and (b) a plurality of through holes in the substantially planar surface.

Implementations may include one or more of the features in paragraph 12 above in any combination.

In general, in yet another aspect, a bobbin for an electro-acoustic driver includes an outer surface, a substantially planar surface at an end of the bobbin, and a bobbin axis that is substantially coaxial with a housing axis. The bobbin is disposable inside a housing and configured to move along the bobbin axis. The substantially planar surface at the end of the bobbin is securable to an acoustic diaphragm. The bobbin includes one or more of (a) legs extending from the outer surface to the substantially planar surface, (b) a wall which extends about substantially all of a perimeter of the planar surface, and (c) a plurality of through holes in the substantially planar surface.

Implementations may include one or more of the following features and features in paragraph 12 above in any combination. The wall stands proud of the planar surface by between about 2 to about 15 microns. The wall has a thickness of between about 5 microns to about 35 microns. The wall is substantially in the shape of an annular ring. The bobbin includes all of (a) legs extending from the outer surface to the substantially planar surface, (b) the wall, and (c) the plurality of through holes in the substantially planar surface.

### BRIEF DESCRIPTION OF THE DRAWINGS

The above and further advantages of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG.1A, FIG. 1B and FIG. 1C are a perspective view, a cutaway view and an exploded cutaway view, respectively, of an electro-acoustic driver.

FIG. 2 is an illustration of the diaphragm of FIGS. 1A to 1C.

FIG. 3 is a cross-sectional side view of the housing, bobbin and coil assembly of FIGS. 1A to 1C according to an example in which an inner region of the diaphragm is stiffened by an adhesive.

FIG. 4 is an alternative example in which a rigid object is used to stiffen the inner region of the diaphragm.

FIG. 5 is another alternative example in which a bobbin includes a planar surface to stiffen the inner region of the diaphragm.

FIGS. 6A-C are perspective, top and side views of another alternative example of a bobbin.

### DETAILED DESCRIPTION

Modern in-ear headphones, or earbuds, typically include microspeakers. The microspeaker may include a coil wound on a bobbin that is attached to an acoustic diaphragm. Motion of the diaphragm due to an electrical signal provided to the coil results in generation of an acoustic signal that is responsive to the electrical signal. The microspeaker may include a housing, such as a sleeve or tube, which encloses the bobbin and coil, and a magnetic structure. As the size of the earbud decreases, it becomes increasingly difficult to fabricate the acoustic diaphragm and surrounding suspension at one end of the bobbin and housing.

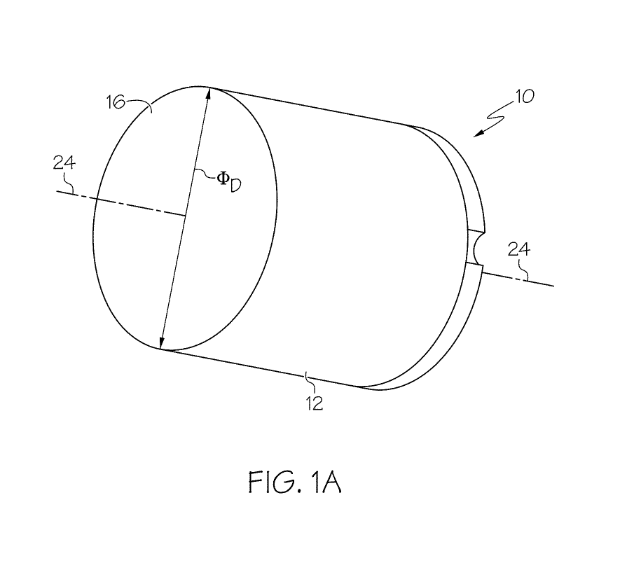

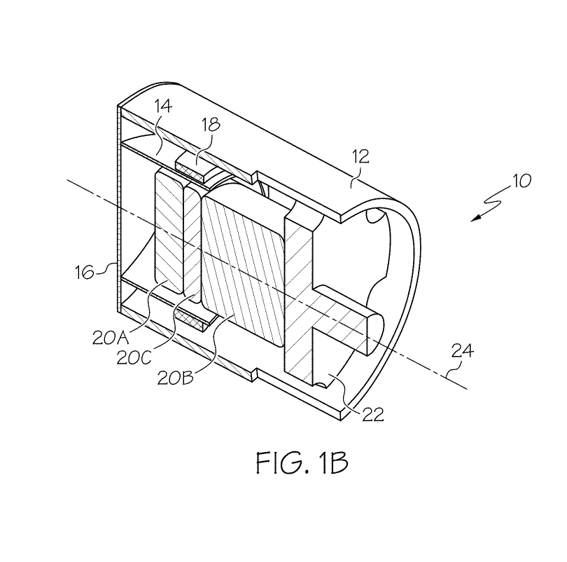

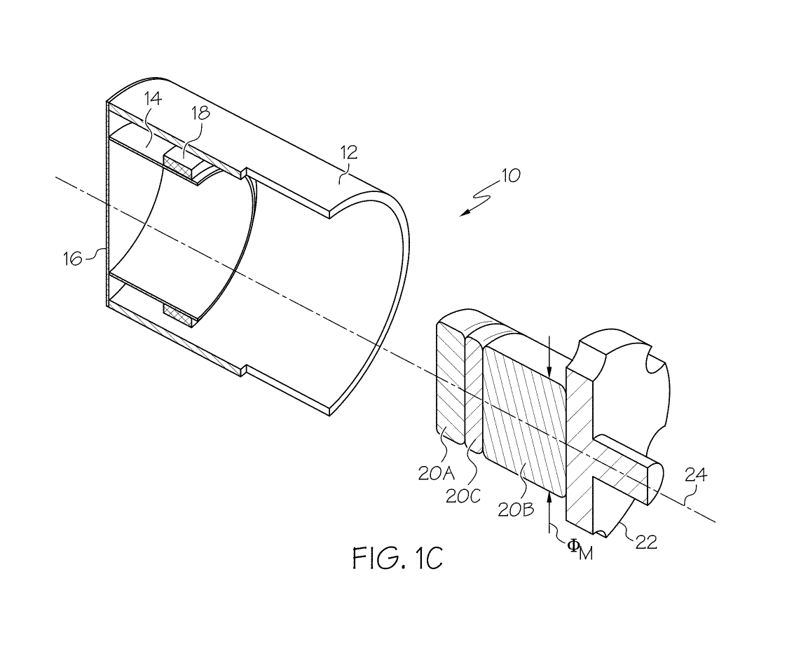

FIG. 1A, FIG. 1B and FIG. 1C are a perspective view, a cutaway perspective view and an exploded cutaway view, respectively, of an example of an electro-acoustic driver 10 (e.g., a microspeaker) that can be used in a miniature earbud. The microspeaker 10 includes a cylindrical housing 12 having an opening at both ends. Inside the housing 12 is a bobbin 14 that is nominally cylindrical in shape and open at both ends. In some examples, the housing 12 is made of stainless steel and the bobbin 14 is made of a polyimide (e.g., KAPTON®) or polyethylene terephthalate (PET) (e.g., MYLAR®). The housing 12 and bobbin 14 are secured at one of their open ends to a diaphragm, or membrane, 16 formed of a compliant material such as an elastomer. A coil assembly 18 is wound onto an outside surface of the bobbin 14. The coil assembly 18 includes a winding of an electrical conductor and may include a structure to hold the winding is a desired shape and/or to secure the winding on the outer surface of the bobbin 14. A magnet assembly 20 is secured to a platform 22 at an end of the housing 12 that is opposite to the diaphragm 16. The magnet assembly 20 includes two magnet pieces 20A and 20B that can be, for example neodymium magnets, and an intervening coin 20C. The magnet assembly 20 extends along a housing axis 24 (i.e., a cylinder axis) and into an open region inside the bobbin 14. The axis of the bobbin 14 is substantially co-axial with the housing axis 24.

The electro-acoustic driver 10 may be miniaturized such that the outer diameter φH of the housing and the diameter φD of the diaphragm 16 are less than about 4.7 mm. The small dimensions present various fabrication problems, including how to provide a small acoustic diaphragm supported by a compliant surround.

In some examples, the housing 12 has an outside diameter φH that is less than about 8 mm. In some examples, the housing 12 has an outside diameter φH that is less than about 4.5 mm. In other examples, the housing 12 has an outside diameter φH that is between about 3.0 mm and 4.5 mm. In other examples, the housing 12 has an outside diameter φH that is between about 3.3 mm and 4.2 mm. In other examples, the housing 12 has an outside diameter φH that is between about 3.6 mm and 3.9 mm. In some examples, the magnet pieces 20 have a diameter φM that is between about 1.5 mm and 4.5 mm. In other examples, the magnet pieces 20 have a diameter φM that is between about 2.0 mm and 4.0 mm. In other examples, the magnet pieces 20 have a diameter φM that is between about 2.5 mm and 3.5 mm.

The radiating area is approximately equal to the area of an inner (central) region of the diaphragm 16 that is stiffened in any one of a variety of ways, including those described in detail below, for relatively higher frequencies above where the non-stiffened portion of the diaphragm 16 (i.e. a surround) starts to break up. For relatively lower frequencies below these higher frequencies about half of the surround also contributes to the radiating area of the diaphragm.

In some examples, a ratio of the radiating area to the total cross sectional area of the driver 10 is about 0.7. In some examples, a ratio of the radiating area to the total cross sectional area of the driver 10 is between 0.57 and 0.7. In some examples, a ratio of the radiating area to the total cross sectional area of the driver 10 is between 0.6 and 0.67. In some examples, a ration of the radiating area to the total cross sectional area of the driver 10 is between 0.62 and 0.65.

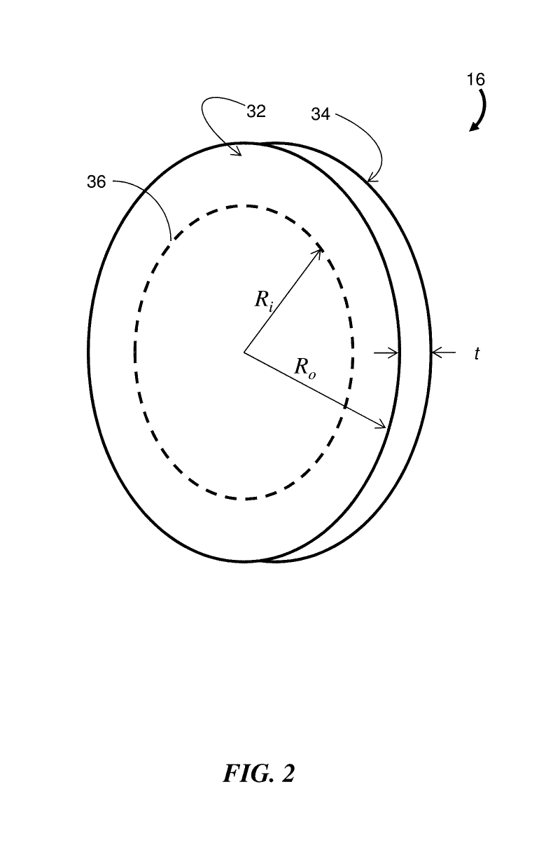

Referring also to FIG. 2, the diaphragm 16 is shown in isolation with its thickness t exaggerated to simplify identification of various features. The diaphragm 16 may be formed of an elastomeric material such as a volume of liquid silicone rubber that is cured to provide the desired thickness t and to adhere to an end of the bobbin 14 and an end of the housing 12. The diaphragm 16 has a perimeter, i.e., the circumferential outer edge at a radius Ro, a front surface 32 and a back surface 34. The diaphragm 16 includes an inner region inside the dashed circular line 36 of radius Ri and an outer region defined by an annular shape that extends from the dashed circular line 36 to the perimeter. The smaller radius Ri is approximately equal to the outer diameter of the cylindrical bobbin 14 and the larger radius Ro is approximately equal to the outer diameter of the housing 12. By way of non-limiting examples, the diaphragm thickness t can be a few tens of microns to more than 100 μm and the diameter Ro may be less than 4.7 mm.

The bobbin 14 moves substantially along its axis, and the housing axis 24, in response to an electrical current conducted through the winding of the coil assembly 18. This motion causes the inner region of the diaphragm 16 to move axially and displace air to thereby generate an acoustic signal.

The diaphragm 16 has a substantially planar shape when at rest, that is, when no electrical signal is applied to the winding of the coil assembly 18 to generate sound. When the microspeaker 10 is driven by an electrical signal to cause a motion of the bobbin 14 along the housing axis 24, the compliant nature of the diaphragm 16 results in its deformation. The inner region of the diaphragm 16 acts as an acoustic diaphragm that is used to generate the acoustic signal; however, due to the low value of Young's modulus for the diaphragm 16, the inner region can behave similar to a drum head. In particular, the inner region can exhibit unwanted structural resonances with the operating frequency band of the driver 10 and can result in a reduction in driver efficiency.

In various examples described below, the inner region of the diaphragm 16 is stiffened, or made rigid, by a stiffening element to substantially reduce or eliminate unwanted resonances during operation. The outer region of the diaphragm 16 is a compliant suspension that surrounds the stiffened inner region. In one example, the stiffening element is a rigid layer of material that is secured to the back surface 34 of the diaphragm 16 over the inner region and which is also secured to the adjacent portion of the inner surface of the bobbin 14. Alternatively, the stiffening element is a rigid object that is secured to the back surface 34 of the diaphragm 16 within the inner region. The object may be a standalone structure (e.g., a solid disc) or the object may be a structural feature of the bobbin. As a result of the stiffening of the inner region, unwanted resonance frequencies are shifted out of the operating bandwidth of the electro-acoustic driver 10 and/or the displacement of the diaphragm 16 at these resonance frequencies is substantially reduced. Consequently, a smoother acoustical frequency response can be achieved. In addition, stiffening of the inner region has an additional benefit of increasing the effective piston area of the electro-acoustic driver to thereby increase the sound pressure output for a particular bobbin displacement magnitude.

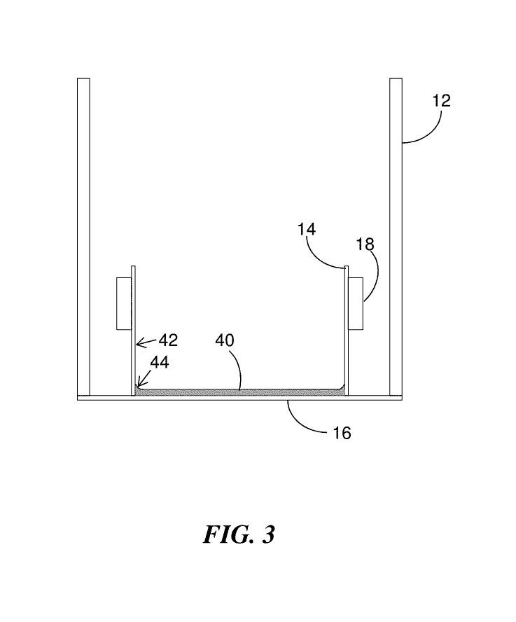

FIG. 3 shows a cross-sectional side view of the housing 12, bobbin 14 and coil assembly 18 according to one example in which the inner region of the diaphragm 16 is stiffened. A small quantity of adhesive is dispensed into the “cup-shaped” structure defined by the bobbin 14 and diaphragm 16 to partially fill the cup. An adequate volume of adhesive is used to ensure that the inner region of the diaphragm 16 is fully covered by the adhesive layer. The adhesive is then cured to form a rigid layer 40 that adheres to a portion of the inner surface 42 of the bobbin 14 and the back surface 34 (see FIG. 2) of the diaphragm 16. A meniscus 44 may form along the inner wall and improve adhesion to the bobbin 14.

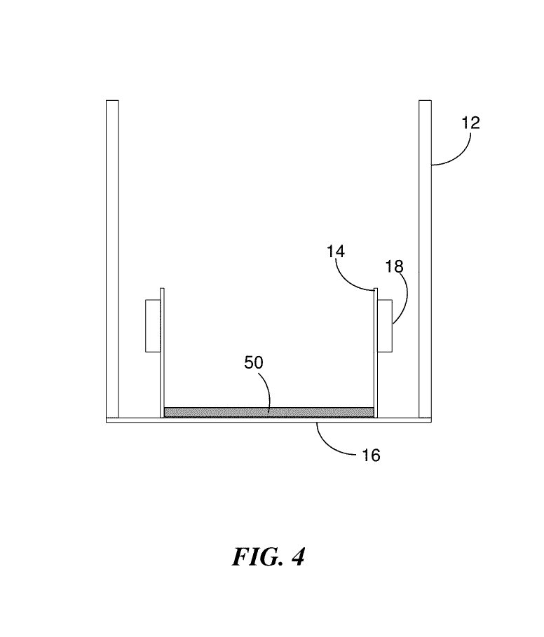

FIG. 4 shows an alternative example in which a rigid object 50 (e.g., disc) is used to stiffen the inner region of the diaphragm 16. The disc 50 may be a high strength thermoplastic thin film such as a polyetherimide (e.g., ULTEM®). The disc 50 has a diameter that is less than the inner diameter of the bobbin 14 to enable the disc 50 to be inserted into the bobbin 14; however, the difference in the diameters is kept small to maximize contact with the inner region of the diaphragm 16. A thin layer of a bonding agent, or adhesive, may be used to bond the disc 50 to the inner region of the diaphragm 16. The bonding agent or adhesive may also be used to bond to the inner cylindrical surface of the bobbin 14. Alternatively, the disc 50 may be placed on top of an uncured layer of an elastomeric material (e.g., liquid silicone rubber) used to create the diaphragm 16. Subsequent curing of the elastomeric layer results in a bond of the diaphragm 16 directly to the disc 50 and the end of the bobbin 14.

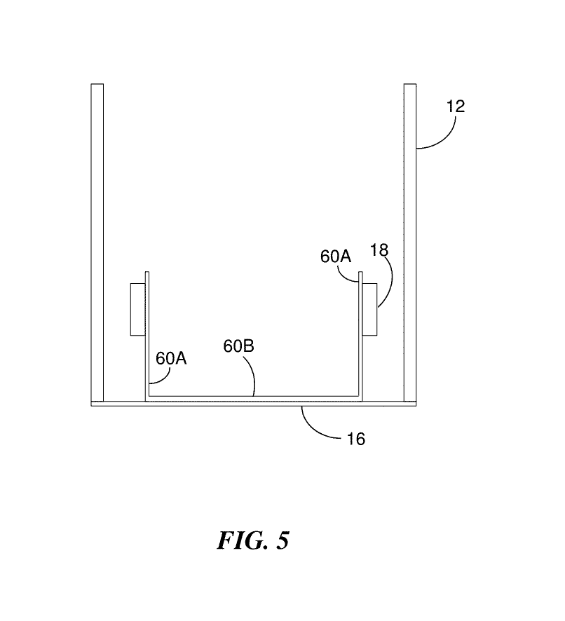

FIG. 5 shows another alternative example in which a bobbin 60 contains structure that is used to stiffen the inner region. The bobbin 60 has a cylindrical portion 60A similar to the bobbin 14 of FIG. 3 and FIG. 4; however, the bobbin 60 also includes an end surface 60B at one end. The end surface 60B may be integrated with the cylindrical portion 60A as a single body. In an alternative configuration, the end surface 60B may be formed independently and then secured to the end of the cylindrical portion 60A. The end surface 60B may be fixed to the back surface 34 (see FIG. 2) of the diaphragm 16 along the inner region using a bonding agent or adhesive. Alternatively, the end surface 60B may be disposed within an uncured layer of an elastomeric material used to create the diaphragm 16 so that subsequent curing of the elastomeric material causes the diaphragm 16 to adhere to the surface 60B.

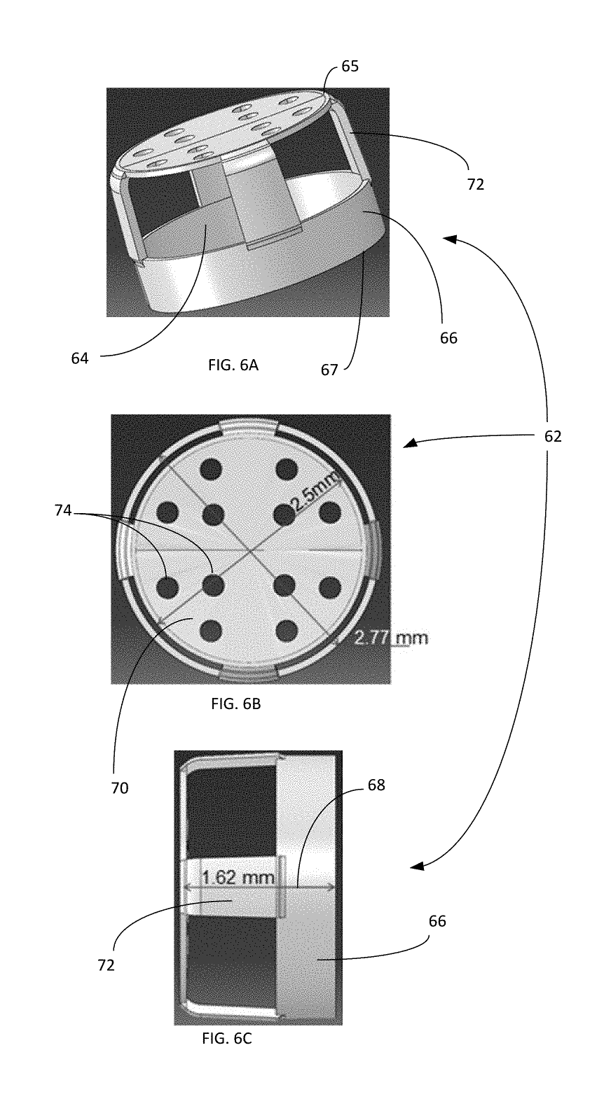

FIG. 6A-C show another example of a bobbin 62 having an inner surface 64, an outer surface 66 and a bobbin axis 68. The bobbin 62 is configured to hold a winding of an electrical conductor (not shown) on the outer surface 66 of a continuous cylindrical section 67. The bobbin 62 has a substantially planar surface 70 at an end of the bobbin. The substantially planar surface 70 is substantially normal to the bobbin axis 68 and can be fixed to the back surface of the diaphragm at the inner region (as discussed above). The stiffening element discussed above can be the substantially planar surface 70 of the bobbin 62.

The substantially planar surface 70 and the portion of the bobbin 62 on which the surface 70 resides can have a small radius to it so that this surface is slightly convex or concave. This small radius substantially increases the stiffness of this portion of the bobbin which allows thickness of this portion to be reduced, thereby reducing the mass of the bobbin. A small concavity or convexity provides the benefits of having a somewhat flat surface (to place on a flat elastomer film such as the diaphragm 16 mentioned above)) and provides some of the benefits of a curved surface (e.g. increased stiffness).

The bobbin 62 includes legs 72 extending from the outer surface 66 to the substantially planar surface 70. In this example the bobbin includes four legs, but there could be as few as two legs if they are wide enough to provide sufficient rigidity to the bobbin. A plurality of through holes 74 are provided in the substantially planar surface 70. The holes 70 (a) provide an escape path for air when the diaphragm is being secured to the bobbin 62, and (b) reduce the overall mass of the bobbin. The bobbin 62 can be made by a micro injection molding process and is preferably made of plastic.

The bobbin 62 also includes a wall (or knife edge) 65 which extends about substantially all of a perimeter of the planar surface 70. The wall 65 preferably stands proud of the planar surface 70 by between about 2 to about 15 microns and has a thickness of between about 5 microns to about 35 microns. In this example the wall is substantially in the shape of an annular ring, but the wall could be in other shapes such as a square, rectangle, triangle or pentagon. The purpose of the wall 65 is to initiate contact with an adhesive layer that is used to secure the bobbin 62 to a diaphragm. Without the wall 65, or if the transition from the planar surface 70 to the legs 72 is not sharp, the location of the adhesive coming in contact with the planar surface 70 can see relatively large changes for a small location error, thereby effecting the symmetry of the transducer about the bobbin axis 68. As shown in FIG. 6B, in this example the bobbin 62 has an outer diameter of 2.77 mm and a diameter to an outside of the wall 65 of 2.5 mm. As shown in FIG. 6C, in this example the bobbin 62 has a dimension along the bobbin axis 68 of 1.62 mm.

A number of implementations have been described. Nevertheless, it will be understood that the foregoing description is intended to illustrate, and not to limit, the scope of the inventive concepts which are defined by the scope of the claims. Other examples are within the scope of the following claims.

What is claimed is:

1. An electro-acoustic driver comprising:
a diaphragm formed of a compliant material and having a perimeter, a front surface, a back surface, an inner region and an outer region between the perimeter and the inner region, and a substantially planar shape when the diaphragm is at rest;
a bobbin having an inner surface, an outer surface and a bobbin axis, the bobbin configured to hold a winding of an electrical conductor on the outer surface;
a housing having an end and a housing axis that is substantially coaxial with the bobbin axis, the perimeter of the diaphragm being fixed to the end of the housing; and
a stiffening element fixed to one or more of the front surface and the back surface at the inner region of the diaphragm,
wherein a motion of the bobbin along the bobbin axis generates a movement of the inner region of the diaphragm to thereby generate an acoustic signal that propagates from the front surface of the diaphragm, wherein the bobbin further comprises a substantially planar surface at an end of the bobbin, the substantially planar surface being normal to the bobbin axis and fixed to the back surface of the diaphragm at the inner region, and wherein the stiffening element comprises the substantially planar surface of the bobbin, and wherein the bobbin includes one or more of (a) legs extending from the outer surface to the substantially planar surface, and (b) a plurality of through holes in the substantially planar surface.

2. The electro-acoustic driver of claim 1 wherein the substantially planar surface is fixed directly to the back surface of the diaphragm.

3. The electro-acoustic driver of claim 1 further comprising a layer of adhesive to fix the substantially planar surface of the bobbin to the back surface of the diaphragm at the inner region.

4. The electro-acoustic driver of claim 1 wherein the bobbin has an outer diameter and the inner region of the diaphragm has a diameter that is substantially equal to the outer diameter of the bobbin.

5. The electro-acoustic driver of claim 4 wherein the outer region has an annular shape.

6. The electro-acoustic driver of claim 1 wherein the bobbin includes both of (a) legs extending from the outer surface to the substantially planar surface, and (b) the plurality of through holes in the substantially planar surface.

7. The electro-acoustic driver of claim 1 wherein the bobbin includes four legs extending from the outer surface to the substantially planar surface.

8. An electro-acoustic driver, comprising:
a housing having a cylindrical shape and a housing axis;
a bobbin having an outer surface, a substantially planar surface at an end of the bobbin, and a bobbin axis that is substantially coaxial with the housing axis, the bobbin disposed inside the housing and configured to move along the bobbin axis;
an acoustic diaphragm secured to the substantially planar surface at the end of the bobbin; and
a compliant suspension surrounding the acoustic diaphragm and secured to the acoustic diaphragm and the housing, wherein the bobbin includes one or more of (a) legs extending from the outer surface to the substantially planar surface, and (b) a plurality of through holes in the substantially planar surface.

9. The electro-acoustic driver of claim 8 wherein the substantially planar surface is fixed directly to a back surface of the diaphragm.

10. The electro-acoustic driver of claim 8 further comprising a layer of adhesive to fix the substantially planar surface of the bobbin to a back surface of the diaphragm.

11. The electro-acoustic driver of claim 8 wherein the bobbin has an outer diameter and an inner region of the diaphragm has a diameter that is substantially equal to the outer diameter of the bobbin.

12. The electro-acoustic driver of claim 11 wherein the outer region has an annular shape.

13. The electro-acoustic driver of claim 8 wherein the bobbin includes both of (a) legs extending from the outer surface to the substantially planar surface, and (b) the plurality of through holes in the substantially planar surface.

14. The electro-acoustic driver of claim 8 wherein the bobbin includes four legs extending from the outer surface to the substantially planar surface.

15. A bobbin for an electro-acoustic driver, comprising:
an outer surface, a substantially planar surface at an end of the bobbin, and a bobbin axis that is substantially coaxial with a housing axis, the bobbin being disposable inside a housing and configured to move along the bobbin axis, the substantially planar surface at the end of the bobbin being securable to an acoustic diaphragm, wherein the bobbin includes one or more of (a) legs extending from the outer surface to the substantially planar surface, (b) a wall which extends about substantially all of a perimeter of the planar surface, and (c) a plurality of through holes in the substantially planar surface.

16. The bobbin of claim 15 wherein the wall stands proud of the planar surface by between about 2 to about 15 microns.

17. The bobbin of claim 15 wherein the wall has a thickness of between about 5 microns to about 35 microns.

18. The electro-acoustic driver of claim 15 wherein the wall is substantially in the shape of an annular ring.

19. The electro-acoustic driver of claim 15 wherein the bobbin includes all of (a) legs extending from the outer surface to the substantially planar surface, (b) the wall, and (c) the plurality of through holes in the substantially planar surface.

20. The electro-acoustic driver of claim 15 wherein the bobbin includes four legs extending from the outer surface to the substantially planar surface.
